(19) United States
(12) Patent Application Publication
(10) Pub. No.: US 2017/0118435 A1
(43) Pub. Date: Apr. 27, 2017

(54) Image Sensor with Two or More Image Areas and an Endoscope Using the Same

(71) Applicant: EndoChoice, Inc., Alpharetta, GA (US)

(72) Inventors: Leonid Krivopisk, Nesher (IL); Yuri Gershov, Haifa (IL); Yaniv Kirma, Karcur (IL); Idan Levy, Hadera (IL)

(21) Appl. No.: 15/335,660

(22) Filed: Oct. 27, 2016

Related U.S. Application Data
(60) Provisional application No. 62/246,797, filed on Oct. 27, 2015.

(51) Int. Cl. H04N 5/3745; H04N 5/369; H04N 5/378; H04N 5/225

(52) U.S. Cl. CPC H04N 5/37455; H04N 5/2254; H04N 5/3698; H04N 5/378; H04N 2005/2255

(57) ABSTRACT

An image sensor with multiple pixel arrays is adapted to receive and process imaging data captured through multiple viewing elements oriented in different directions. Each pixel array is configured to receive the imaging data captured by a different imaging device oriented in an associated direction. Employing a single image sensor for multiple cameras leads to efficient design layout and optimal use of chip space. The image sensor is used in an endoscope system comprising multiple viewing elements, such as front and side facing cameras.

### CROSS-REFERENCE TO RELATED APPLICATIONS

The present specification relies on, for priority, U.S. Patent Provisional Application No. 62/246,797, entitled “Image Sensor with Two or More Image Areas and An Endoscope Using the Same”, and filed on Oct. 27, 2015.

### FIELD

The present specification generally relates to an image sensor, and more specifically to an image sensor with two or more image areas which are adapted to receive and store optical image data captured by different imaging devices aligned in the direction of each area.

### BACKGROUND

An image sensor is a device that converts an optical image into an electronic signal. It is used mostly in digital cameras, camera modules and other imaging devices. There are two main types of image sensors: Charge-Coupled Device (“CCD”) sensors and Complementary Metal Oxide Semiconductor (“CMOS”) sensors. The majority of early image sensors were of the CCD type. The early CMOS sensors suffered from poor light sensitivity and high noise levels that limited their usefulness. Recent advances in CMOS technology have led to the development of high performance CMOS sensors that are quickly replacing CCDs in a host of applications, particularly in those where speed, power consumption, size, and on-chip functionality are important factors.

Image sensors typically include a two dimensional array of pixels fabricated on a semiconductor substrate. Each pixel comprises a sensing element, such as a photodiode, which is capable of converting the optical image into an electronic signal, and an access circuit that couples the sensing element to control circuits through address and signal lines.

Generally, in imaging devices such as a camera, there is a single image sensor which is configured to store the imaging data captured by the objective lens of the camera. Certain high precision systems, such as endoscopes, comprise multiple cameras and an equal number of image sensors.

Endoscopes have attained great acceptance within the medical community since they provide a means for performing procedures with minimal patient trauma while enabling the physician to view the internal anatomy of the patient. Over the years, numerous endoscopes have been developed and categorized according to specific applications, such as cystoscopy, colonoscopy, laparoscopy, and upper GI endoscopy, among others. Endoscopes may be inserted into the body's natural orifices or through an incision in the skin.

An endoscope typically comprises an elongated tubular shaft, rigid or flexible, having a camera associated with illumination components, such as (Light Emitting Diodes) LEDs and fiber optics, at its distal end. The shaft is connected to a handle which sometimes includes an ocular component for direct viewing. Viewing is also usually possible via an external screen. Various surgical tools may be inserted through a working channel in the endoscope for performing different surgical procedures. The most important part of an endoscope, the camera, is located in the tip section of the endoscope.

U.S. patent application Ser. No. 13/119,032, assigned to EndoChoice Innovation Center Ltd. and incorporated herein by reference, describes the use of multiple cameras in a single endoscope for an improved field of view, which includes a front-pointing camera and multiple side-pointing cameras which are located in the tip section. The cameras comprise small image sensors that are mounted in the tip and are connected by wires to a host measurement device that stores image information generated by the image sensors.

Such high precision endoscopes comprising multiple cameras and an equal number of image sensors occupy significant chip space in the tip of the endoscope. Endoscopes are required to enter smaller and smaller organs such as tiny blood vessels, and thus there is increasing focus on reducing the size of image sensors utilized in endoscopes, thereby reducing overall tip size. Further, in endoscope systems involving the use of multiple cameras as discussed above, the space constraint in the tip is even higher. Hence, there is a need to decrease the size of the overall camera assembly, and reduce the overall space occupied by image sensors in the chip space, in order to keep the overall size of the tip to a minimum.

### SUMMARY

The following embodiments and aspects thereof are described and illustrated in conjunction with systems, tools and methods, which are meant to be exemplary and illustrative, not limiting in scope.

The present specification discloses an image sensor comprising: a plurality of pixel arrays, wherein each pixel array has a unique orientation and is configured to receive imaging data captured by a corresponding imaging device aligned in the direction of said pixel array; and a plurality of analog to digital converters, each of the said converters being coupled to one of said plurality of pixel arrays to convert analog pixel information into a digital format.

Optionally, said image sensor employs CMOS technology.

Optionally, the image sensor further comprises a single processing unit coupled to the plurality of analog to digital converters. Optionally, the image sensor further comprises a differential signaling component adapted to transfer data processed by said processing unit. The differential signaling component may comprise a low-voltage differential signaling (LVDS) component. Optionally, the image sensor further comprises a data transfer module configured to transfer processed imaging data corresponding to each pixel array.

Optionally, the image sensor further comprises a discrete processing unit coupled to each pixel array. Optionally, the image sensor further comprises a differential signaling component adapted to transfer data processed by said discrete processing unit. The differential signaling component used for data transfer may comprise a low-voltage differential signaling (LVDS) component. Optionally, the image sensor further comprises a discrete data transfer module adapted to transfer imaging data processed by said discrete processing unit.

The image sensor may be adapted to receive and store imaging data captured by a plurality of cameras or viewing elements positioned on the tip section of an endoscope.

The present specification also discloses an image sensor comprising: a plurality of pixel arrays wherein each pixel array is configured to receive imaging data captured by a corresponding imaging device; a plurality of analog to digital converters (ADCs), wherein each of said plurality of ADCs is coupled to at least one of said plurality of pixel arrays to convert analog pixel data into a digital format; a plurality of discrete processing units, wherein each of said plurality of discrete processing units is coupled to at least one of said plurality of ADCs corresponding to each of said at least one of said plurality of pixel arrays for processing imaging data corresponding to said pixel array; and a plurality of discrete data transfer modules, wherein each of said plurality of discrete data transfer modules is coupled to each of said plurality of discrete processing units for transmitting data processed by each of said plurality of discrete processing units using at least one differential signaling mechanism.

The present specification also discloses an image sensor comprising: a plurality of pixel arrays wherein each pixel array is configured to receive imaging data captured by a corresponding imaging device; a plurality of analog to digital converters (ADCs), wherein each of the plurality of ADCs is coupled to one of said plurality of pixel arrays to convert analog pixel data into a digital format; a single parallel processing unit coupled to said plurality of ADCs to process imaging data corresponding to said plurality of pixel arrays; and a data transfer module coupled to said parallel processing unit and adapted to transmit data processed by said single parallel processing unit using a differential signaling mechanism.

Optionally, the image sensor further comprises a plurality of data transfer modules coupled to said parallel processing unit wherein each data transfer module is configured to transmit data corresponding to a specific one of said plurality of pixel arrays using a differential signaling mechanism.

The present specification also discloses an image sensor comprising: a plurality of pixel arrays wherein each pixel array is configured to receive and store imaging data captured by a corresponding imaging device; a plurality of ADCs (analog to digital converter), wherein each ADC is coupled to one of said plurality of pixel arrays to convert analog pixel data into a digital format; a plurality of discrete processing units coupled to said plurality of ADCs corresponding to each pixel array for processing imaging data corresponding to said pixel array; and, a single data transfer module coupled to said plurality of discrete processing units for transmitting data processed by said processing units using a differential signaling mechanism.

The present specification also discloses an endoscope system comprising: a main control unit; a control handle coupled to said main control unit for controlling at least one functionality of the endoscope; and, an insertion tube coupled to said control handle wherein the tip section of said insertion tube comprises an image sensor with a plurality of pixel arrays such that each pixel array is configured to store optical imaging data captured by a different camera positioned on said tip section.

The present specification also discloses an imaging system comprising: a plurality of imaging elements aligned in three different directions and adapted to capture imaging data; a prism associated with each of said imaging elements and configured to reflect light toward said plurality of imaging elements in each of the three different directions; and an image sensor comprising: a plurality of pixel arrays, wherein each of said plurality of pixel arrays has a unique orientation corresponding to each of said different directions and is configured to receive imaging data captured by a corresponding one of said plurality of imaging elements; and a plurality of analog to digital converters, each of the plurality of analog to digital converters being coupled to one of said plurality of pixel arrays to convert analog pixel information into a digital format.

Optionally, the image sensor employs CMOS technology.

Optionally, the imaging system further comprises a single processing unit coupled to the plurality of analog to digital converters.

Optionally, the imaging system further comprises a differential signaling component adapted to transfer data processed by said processing unit.

The present specification also discloses an image sensor comprising a plurality of pixel arrays such that each pixel array is configured to store imaging data captured by an imaging device corresponding to said pixel array.

Optionally, said imaging device is an optical lens of a camera.

Optionally, said image sensor employs CMOS technology.

Each of said pixel array may have a unique orientation and may be configured to receive imaging data captured by a corresponding imaging device aligned in its direction. Optionally, a prism is coupled with each imaging device to reflect incoming light rays in the direction of a corresponding pixel array.

Optionally, an ADC converter is coupled to each pixel array to convert analog pixel information into a digital format.

Optionally, a single processing unit is coupled to the plurality of pixel arrays. The image sensor may include a means for transferring data processed by said processing unit using a differential signaling mechanism. Optionally, said differential signaling mechanism used for data transfer comprises LVDS. Optionally, the processed imaging data corresponding to each pixel array is transferred using a separate data transfer module.

Optionally, the image sensor further comprises a discrete processing unit coupled to each pixel array. Optionally, the image sensor further comprises a means for transferring data processed by said discrete processing units using a differential signaling mechanism. Optionally, said differential signaling mechanism used for data transfer comprises LVDS. Optionally, the imaging data processed by each processing unit is transferred using a discrete data transfer module.

Optionally, said image sensor is used to receive and store imaging data captured by a plurality of cameras or viewing elements positioned on the tip section of an endoscope.

The present specification also discloses an image sensor comprising: a plurality of pixel arrays such that each pixel array is configured to receive and store imaging data captured by a different imaging device; a plurality of ADCs (analog to digital converter), each of which is coupled to at least one pixel array to convert analog pixel data into a digital format; a plurality of discrete processing units, each of which is coupled to at least one of the plurality of ADCs corresponding to each pixel array for processing imaging data corresponding to said pixel array; and, a plurality of discrete data transfer modules, each of which is coupled to each processing unit for transmitting data processed by said processing unit using at least one differential signaling mechanism.

The present specification also discloses an image sensor comprising: a plurality of pixel arrays such that each pixel array is configured to receive and store imaging data captured by a different imaging device; a plurality of ADCs (analog to digital converter), each of which is coupled to each pixel array to convert analog pixel data into a digital format; a single parallel processing unit coupled to the plurality of ADCs to process imaging data corresponding to the plurality of said pixel arrays; and, a data transfer module coupled to said parallel processing unit that transmits data processed by said processing unit using a differential signaling mechanism.

The present specification also discloses an image sensor comprising: a plurality of pixel arrays such that each pixel array is configured to receive and store imaging data captured by a different imaging device; a plurality of ADCs (analog to digital converter), each of which is coupled to each pixel array to convert analog pixel data into a digital format; a single parallel processing unit coupled to the plurality of ADCs to process imaging data corresponding to the plurality of said pixel arrays; and, a plurality of data transfer modules coupled to said parallel processing unit wherein each data transfer module is employed to transmit data corresponding to a specific pixel array using a differential signaling mechanism.

The present specification also discloses an image sensor comprising: a plurality of pixel arrays such that each pixel array is configured to receive and store imaging data captured by a different imaging device; a plurality of ADCs (analog to digital converter), each of which is coupled to each pixel array to convert analog pixel data into a digital format; a plurality of discrete processing units coupled to each of the plurality of ADCs corresponding to each pixel array for processing imaging data corresponding to said pixel array; and, a single data transfer module coupled to the plurality of the processing units for transmitting data processed by said processing units using a differential signaling mechanism.

The present specification also discloses an endoscope system comprising: a main control unit; a control handle coupled to said main control unit for controlling at least one functionality of the endoscope; and, an insertion tube coupled to said control handle wherein the tip section of said insertion tube comprises an image sensor with a plurality of pixel arrays such that each pixel array is configured to store optical imaging data captured by a different camera positioned on said tip section.

The aforementioned and other embodiments of the present invention shall be described in greater depth in the drawings and detailed description provided below.

### BRIEF DESCRIPTION OF THE DRAWINGS

These and other features and advantages of the present invention will be appreciated, as they become better understood by reference to the following detailed description when considered in connection with the accompanying drawings, wherein:

FIG. 1 illustrates a layout of a complementary metal oxide semiconductor (CMOS) image sensor;

FIG. 2 illustrates basic components in an image sensor having multiple imaging areas in accordance with an embodiment of the present specification;

FIG. 3 illustrates an exemplary layout design of a CMOS image sensor comprising multiple image areas coupled to multiple processing units and multiple parallel to serial (P/S) converter and low-voltage differential signaling (LVDS) modules in accordance with an embodiment of the present specification;

FIG. 4 illustrates an exemplary design layout of a CMOS image sensor comprising multiple image areas and a single processing unit coupled to multiple P/S converter and LVDS modules in accordance with an embodiment of the present specification;

FIG. 5 illustrates an exemplary design layout of a CMOS image sensor comprising multiple image areas and a single processing unit coupled to a single P/S converter and LVDS module in accordance with an embodiment of the present specification;

FIG. 6 illustrates an exemplary design layout of a CMOS image sensor comprising multiple image areas and multiple processing units coupled to a single P/S converter and LVDS module in accordance with an embodiment of the present specification;

FIG. 7A illustrates a system comprising multiple cameras coupled with a single image sensor in accordance with an embodiment of the present specification;

FIG. 7B illustrates the relative positions and orientations of multiple image areas on an image sensor in accordance with one embodiment of the present specification;

FIG. 7C illustrates the relative positions and orientations of multiple image areas on an image sensor in accordance with another embodiment of the present specification;

FIG. 7D illustrates the relative positions and orientations of multiple image areas on an image sensor in accordance with another embodiment of the present specification; and

FIG. 7E illustrates the relative positions and orientations of multiple image areas on an image sensor in accordance with yet another embodiment of the present specification.

### DETAILED DESCRIPTION

The present specification describes an image sensor with multiple image areas which are adapted to receive and store imaging data captured and subsequently transmitted by multiple imaging devices, such as optical lenses in cameras. In applications that employ multiple imaging devices and have space restrictions, using a separate image sensor for each imaging device leads to significant inefficiency in the design layout and waste of space on the semiconductor chip.

In an embodiment, the present specification describes an image sensor comprising multiple pixel arrays wherein each pixel array corresponds to a separate image area and is configured to receive imaging data from a specific imaging device (lens) corresponding to that image area. In an embodiment, the image sensor comprises other components, such as power module, clock generator, timing generator, and other such peripheral components, which are common and shared by various pixel arrays on the chip. In an embodiment, each image area or pixel array has a specific orientation in the vertical and horizontal directions and is configured to receive imaging data captured by a specific camera which is aligned in its direction.

It may be noted that a design layout involving a single sensor with multiple pixel arrays is easier to implement than a design layout involving multiple image sensors. Further, the sharing of various components mentioned above leads to significant reduction in the total space utilized by the imaging apparatus. In an embodiment, the image sensor comprising multiple image areas as described in the present specification is developed using CMOS (Complementary Metal Oxide Semiconductor) technology which is a commonly used platform for manufacturing image sensors. However, one of skilled in the art would appreciate the image sensor comprising multiple image areas as disclosed in the present specification can also be implemented on other technology platforms which are currently available or which might be developed in the future.

In an embodiment, the image sensors of the present specification comprise separate processing units and data transfer modules coupled to each image area, to process the imaging data and subsequently transmit the same to external devices or applications. In other embodiments, either the processing unit or the data transfer module or, in some cases, both the processing unit and the data transfer module, are shared across various image areas to further reduce the chip space required for fabricating the system. In an embodiment, in case any component, such as the processing unit or data transfer module, is shared across various image areas, the processing speed or data transfer speed requirement of the corresponding component is accordingly enhanced to avoid any time lag.

The present specification is directed towards multiple embodiments. The following disclosure is provided in order to enable a person having ordinary skill in the art to practice the invention. Language used in this specification should not be interpreted as a general disavowal of any one specific embodiment or used to limit the claims beyond the meaning of the terms used therein. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

It should be noted herein that any feature or component described in association with a specific embodiment may be used and implemented with any other embodiment unless clearly indicated otherwise.

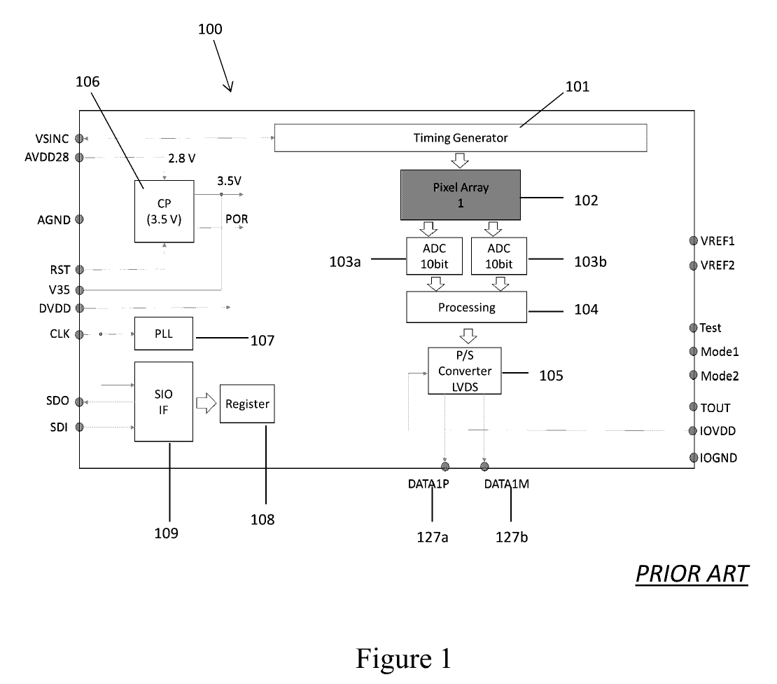

FIG. 1 illustrates the layout of a typical CMOS image sensor 100. As shown in FIG. 1, the CMOS image sensor 100 comprises a timing generator 101 which is coupled to an image area or pixel array 102. The image area 102 is adapted to receive imaging data captured by a corresponding imaging device, such as an optical lens assembly of a camera. The image area 102 comprises a two dimensional array of pixels in which each pixel is adapted to store color and brightness information of a specific coordinate of the optical image. Each pixel in the image area 102 comprises a sensing element, such as a photodiode, which is capable of converting the optical image into an electronic signal, and an access circuit that couples the sensing element to control circuits through address and signal lines.

In the above embodiment, the image area 102 is coupled to two 10 bit ADCs (Analog to Digital Converters) 103a and 103b which convert the analog information stored in the pixel array into a digital format. The digitized pixel information is subsequently transmitted from ADC 103a and ADC 103b to the processing unit 104 where it is further processed and converted into specific digital formats as per the requirement. The final digital imaging data is subsequently transmitted using a parallel to serial interface module 105 through a differential signaling mechanism, such as LVDS (low-voltage differential signaling). The output signals from a P/S converter and LVDS module 105 are available at the pins/pads DATA1P 127a and DATA1M 127b in FIG. 1.

In the above embodiment, the CMOS image sensor 100 comprises a charge pump (CP) 106 which is used to charge up or down an external power supply voltage and provide a specific constant voltage supply as required by the image sensor 100. The CMOS image sensor 100 further comprises a phase locked loop circuit (PLL) 107 which provides an output signal that is synchronized with a reference input signal and helps in stabilizing the sensor operation by controlling the phase difference of various signals. The CMOS image sensor 100 also comprises a serial input/output (I/O) interface 109 to enable data communication with external devices and applications. The serial I/O interface 109 is coupled to the memory register 108 which contains the instructions/programs to control various other components in the image sensor 100.

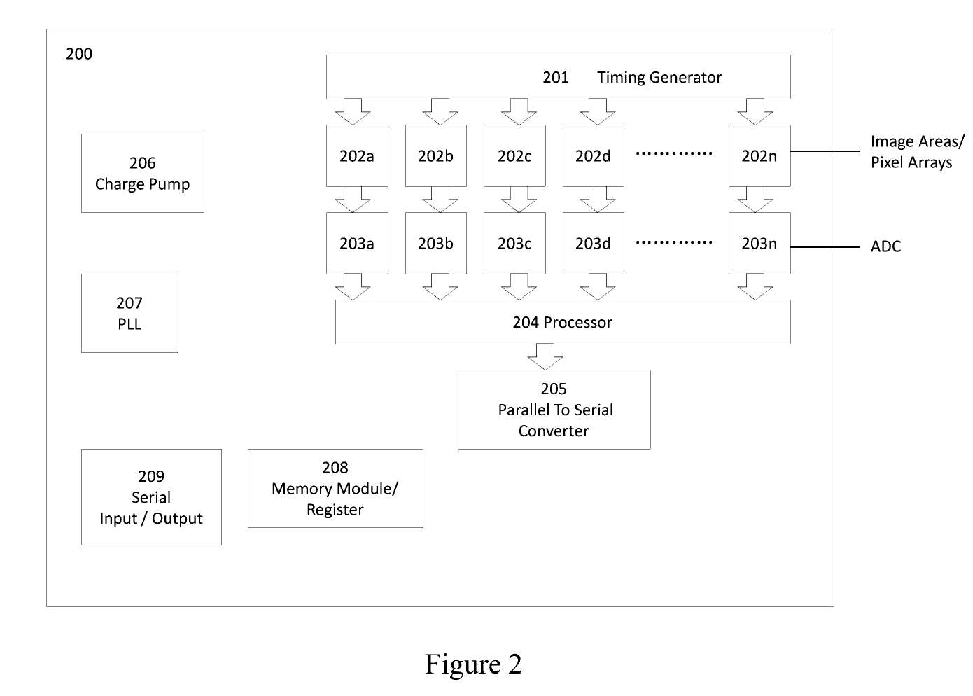

FIG. 2 illustrates basic components in an image sensor 200 having multiple imaging areas 202a to 202n in accordance with an embodiment of the present specification. As shown in FIG. 2, image sensor 200 comprises a timing generator 201 and a plurality of pixel arrays or image areas 202a to 202n. In an embodiment, the timing generator 201 is controlled by the computer program/instructions stored in the memory module or register 208. The timing generator 201 provides the clock signals to synchronize the multiple image areas 202a to 202n. In an embodiment, each of the plurality of image areas 202a to 202n is configured to receive imaging data from a corresponding optical lens (not shown) aligned in its direction. In the above embodiment, as an exemplary illustration, the number of image areas are shown as n. The actual number of image areas, and thus, the number n, depends on the number of imaging devices (lenses). In some embodiments, the number of image areas n is equal to the number of imaging devices (lenses). In some embodiments, the number of image areas n ranges from 2 to 5.

In an embodiment, the image sensor 200 comprises a plurality of Analog to Digital convertors (ADCs) 203a to 203n wherein each of the ADC modules 203a to 203n is coupled to a distinct and corresponding pixel array 202a to 202n, resulting in a one to one correspondence between each pixel array and ADC, such that the analog imaging information stored in the pixel array 202a is sent to ADC 203a, analog imaging information stored in the pixel array 202b is sent to ADC 203b and so forth, thereby converting the analog imaging information into digital format for further processing.

While in the above embodiment, a single ADC (such as 203a) is coupled with each image area (such as 202a), in another embodiment, two or more ADCs are coupled with each image area to convert the analog imaging information into digital format. In this embodiment, two 10 bit ADCs are coupled to each image area. In another embodiment, three 12 bit ADCs are used for each image area. The number of ADCs and their bit capacity depends on actual system specifications, such as the size of data to be converted and speed requirements. Several different architectures, including the use of a single ADC, or 2- and 3-ADC architectures or an array of ADCs, can be used depending on the application requirement.

In an embodiment, the image sensor 200 further comprises a processor 204 coupled to the plurality of ADCs 203a to 203n such that the processor 204 receives the digital imaging information from the plurality of ADC 203a to 203n and processes the same as per the instructions stored in the memory module or register 208 before transmitting them to the output. In an embodiment, the processor 204 converts the data into specific video formats as per the system requirements, such as MPEG and HD video, for further analysis by the user. In other embodiment, instead of a single processing unit coupled to all image areas, the image sensor 200 comprises a separate processing unit coupled to each image area. One of ordinary skill in the art would appreciate that although using multiple processing units may provide a relatively fast system, the methodology will obviously lead to higher space utilization. In one embodiment, after processing the data, the processor 204 outputs the imaging data through a parallel to serial data interface 205. In an embodiment, the data is transferred from the parallel to serial data interface 205 to external systems and applications using a differential signaling method which is a highly reliable approach to transmit data at low voltages.

In an embodiment, the image sensor 200 also comprises a PLL (Phase Locked Loop) 207 which provides an output signal which is synchronized with a reference input signal and helps in stabilizing the sensor operation. In an embodiment, a charge pump 206 is used to charge up or down the external power supply voltage and provide a specific constant voltage supply required by the image sensor 200. In several applications, the available voltage supply may not exactly match the requirement of image sensor components, and the charge pump 206 plays a role in such applications by generating the required voltage supply.

The image sensor 200 comprises a memory module/memory register 208 which stores the data required for functioning of image sensor 200 such as the instructions/computer program to control and operate other components of the image sensor 200. The instructions/computer program stored in the memory register 208 are executed by the processor 204. In an embodiment, image sensor 200 also comprises a serial input/output interface 209 to enable data communication with external systems and devices. In an embodiment, serial I/O interface 209 is coupled to the memory register 208 such that when any other device or application communicates with the image sensor 200, the incoming data is first stored in memory register 208 before being processed and likewise any outgoing data is first stored in memory register 208 before being transmitted through serial I/O interface 209. Though not shown in FIG. 2, various components, such as the charge pump 206, PLL 207, serial I/O interface 209, memory module 208, timing generator 202, processor 204, and parallel to serial convertor 205, communicate with each other through the internal connections on the semiconductor chip. In an embodiment, the image sensor 200 is designed using a CMOS technology platform.

In an embodiment, the image sensor 200 as described in the present specification is used in an endoscope system having multiple viewing elements such that each of the viewing elements or cameras is positioned to capture an image from a different field of view inside a patient's body. An exemplary endoscope tip with multiple viewing elements is described in U.S. patent Publication Ser. No. 14/263,896, entitled “Video Processing in a Compact Multi-Viewing Element Endoscope System”, and filed on Apr. 28, 2014, which is herein incorporated by reference in its entirety.

As known in the art, endoscope tip sections are very small units and require an optimal usage of space during the designing phase. Thus, when multiple cameras in an endoscope share a common image sensor having multiple image areas as described in the present specification, a very efficient usage of available chip space is made. It may further be appreciated that, as the disclosed system comprises only a single sensor, there is no requirement to provide separate connections of power supply unit and other such common components for multiple sensors, thereby significantly saving chip space. Further, the system requires only one set of certain common components, such as the capacitors and resistors corresponding to a single sensor, and hence leads to an efficient usage of chip space. In an embodiment, the endoscopy system as described above comprises three viewing elements or cameras positioned on its distal tip section, including a front camera and two side cameras and accordingly, an image sensor comprising three different image areas is used for this endoscope, wherein a lens assembly corresponding to each camera is coupled to a specific image area in the image sensor.

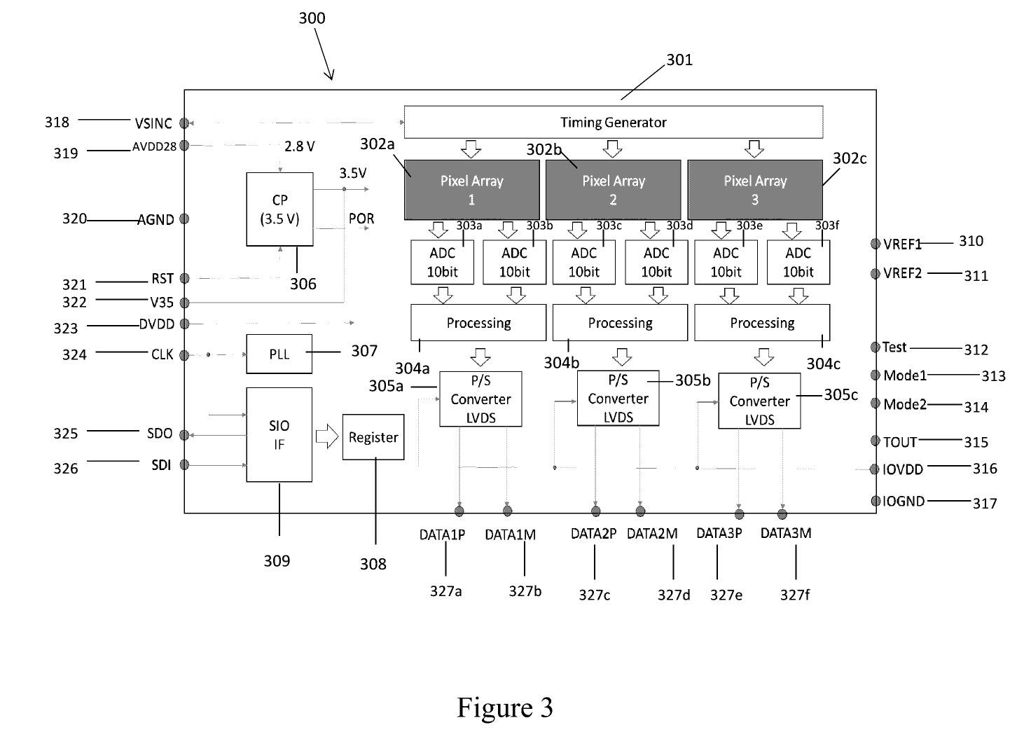

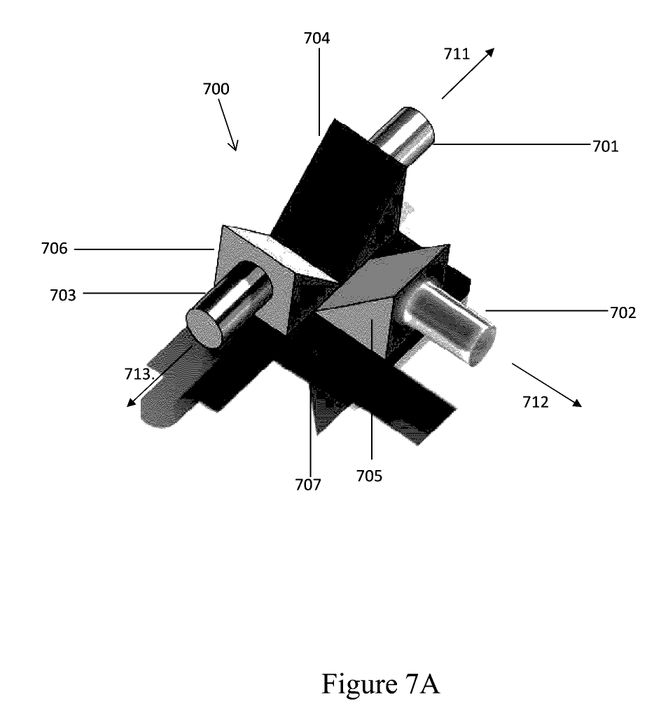

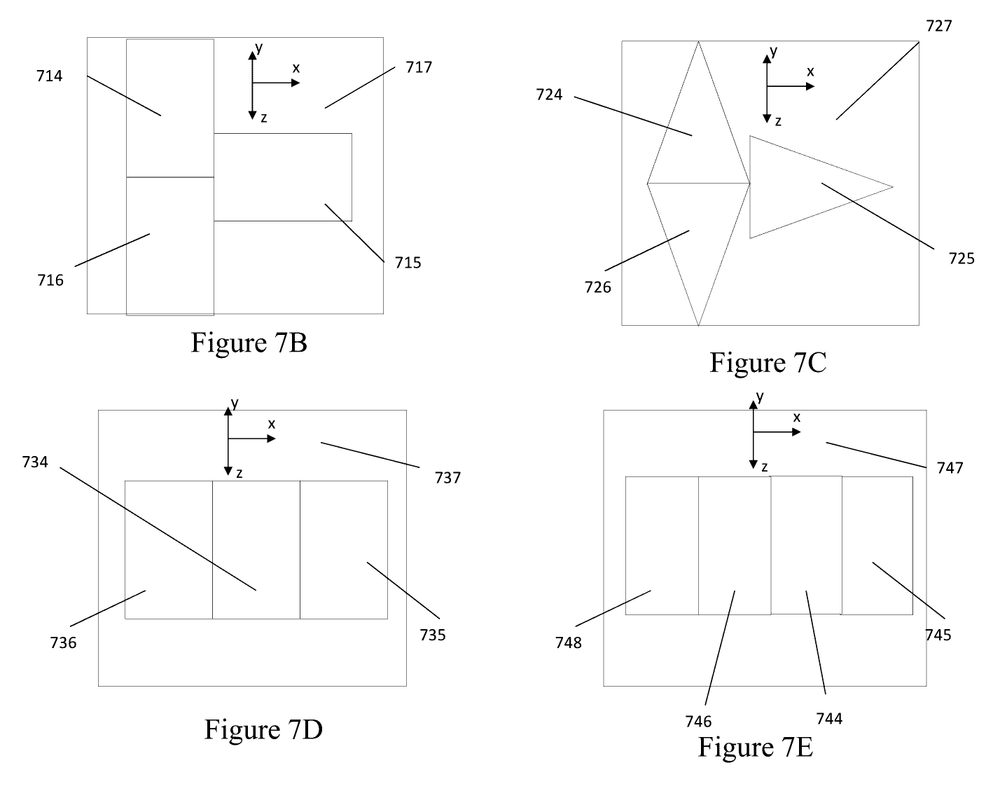

FIG. 3 illustrates the layout design of a CMOS image sensor 300 comprising multiple image areas 302a, 302b and 302c coupled to multiple processing units 304a, 304b and 304c and multiple P/S converter/LVDS modules 305a, 305b and 305c in accordance with an embodiment of the present specification. As shown in FIG. 3, the CMOS image sensor 300 comprises a timing generator 301 which is coupled to three separate pixel arrays or image areas 302a, 302b and 302c. In an embodiment, the timing generator 301 provides the clock signals to synchronize the three image areas 302a, 302b and 302c. The CMOS image sensor 300 described in this embodiment comprises three image areas 302a, 302b and 302c and hence it is suitable for applications that include three cameras, such as the multiple viewing element endoscope described above. In an embodiment, each of the image areas 302a, 302b and 302c has a specific orientation in the vertical and horizontal directions such that each is adapted to receive imaging data captured by the lens assembly of a specific camera oriented in its direction. In various embodiments, the image areas each comprise an equal pixel area of the total pixel area of the image sensor. For example, in an embodiment comprising two image areas, each image area comprises half of the total area of pixels of the image sensor. In another embodiment, wherein the image sensor comprises three image areas, each image area comprises one third of the total area of pixels of the image sensor. In some embodiments, the image areas are angled relative to a flat surface of the image sensor. In other embodiments, as detailed further with respect to FIGS. 7B-7E below, the image areas are flat or coplanar relative to a flat surface of the image sensor. In an embodiment, each image area 302a, 302b and 302c comprises a two dimensional array of pixels in which each pixel is adapted to store color and brightness information of a specific coordinate on the image. In the architecture shown in FIG. 3, each image area 302a, 302b and 302c is coupled to two 10 bit ADCs 303a to 303f which convert the analog information stored in pixels into a digital format. As illustrated in FIG. 3, pixel array 302a is coupled to ADC 303a and ADC 303b, pixel array 302b is coupled to ADC 303c and ADC 303d and pixel array 302c is coupled to ADC 303e and ADC 303f. Pads VREF1 310 and VREF2 311 shown in the layout are the reference output voltages of two ADCs coupled to each pixel array 302a, 302b and 302c. Selection of reference voltages in the ADCs depends on the required ADC resolution and the signal range to be covered. It may be noted that while in the above architecture two 10 bit ADCs are used, in other embodiments, a different number of ADCs and different bit capacity ADCs may be used to implement the ADC function.

In an embodiment, each ADC coupled to a specific image area is also coupled to a corresponding processor, which receives digitized pixel information from the ADC and processes the same in accordance with the system requirements, which are usually predefined and stored in the form of computer instructions. As shown in FIG. 3, ADC 303a and ADC 303b are coupled to a processor 304a. Similarly, ADC 303c and ADC 303d are coupled to a processor 304b and ADC 303e and ADC 303f are coupled to a processor 304c as illustrated. In the above embodiment, a dedicated processor is used to process the digitized pixel information received from each image area 302a, 302b, and 302c, which speeds up the overall process of retrieving and processing the imaging data stored in the CMOS image sensor 300. In an embodiment, each of the processors 304a, 304b and 304c is coupled to a parallel to serial interface 305a, 305b and 305c to transfer the data from processors to an external output.

As known in the art, in digital electronics, noise immunity is defined as the amount of noise a logic circuit or system can tolerate without compromising its performance. Data transmission tends to suffer with an increasing focus on lowering the supply voltage in order to save power, as the noise immunity decreases at lower voltage levels. In such cases, it is advisable to use differential signaling to transmit data which significantly enhances noise immunity. In differential signaling, information is electrically transmitted with two complimentary signals sent over a differential pair of wires. In an embodiment of the present specification, the parallel to serial converters 305a, 305b and 305c comprise a differential voltage signaling mechanism, such as the LVDS (Low-Voltage Differential Signaling) standard. In an embodiment, each of the processors 304a, 304b and 304c is coupled to a corresponding P/S converter/LVDS module 305a, 305b and 305c. Processor 304a is coupled to P/S converter/LVDS module 305a. Similarly, Processor 304b is coupled to P/S converter/LVDS module 305b and Processor 304c is coupled to P/S converter/LVDS module 305c.

For LVDS module 305a, the output signals are available at data pads DATA1P 327a and DATA1M 327b. For LVDS module 305b, the output signals are made available at data pads DATA2P 327c and DATA2M 327d. For LVDS module 305c, the output signals are available at data pads DATA3P 327e and DATA3M 327f.

In an embodiment, the CMOS image sensor 300 comprises a charge pump (CP) 306 which is used to charge up or down the external power supply voltage and provide a specific constant voltage supply required by the image sensor 300. In an embodiment, the charge pump 306 provides a 3.5 volt power supply from an external 2.8 volt supply voltage AVDD28 319 connected to the image sensor 300. The charge pump 306 can be reset using the pin RST 321.

In an embodiment, the CMOS image sensor 300 comprises a PLL 307 which provides an output signal which is synchronized with a reference input signal and helps in stabilizing the sensor operation by controlling the phase difference of various signals. Input pin CLK 324 represents the input clock signal coupled with the PLL 307. In an embodiment, the CMOS image sensor 300 comprises a serial input/output (I/O) interface 309 to enable data communication with external systems and devices. In an embodiment, serial I/O interface 309 is coupled to a memory register 308 such that when any other device or application communicates with the image sensor 300, the incoming data is first stored in memory register 308 before being processed and likewise output data is first stored in memory register 308 before being transmitted through serial I/O interface 309. In an embodiment, the memory register 308 stores the data required for functioning of image sensor 300, such as the instructions/commands to control and operate other components of the image sensor 300. In an embodiment, the memory register 308 contains the instructions/computer program required to control the processors 304a, 304b and 304c such that each of the processors 304a, 304b and 304c works in coordination with the memory register 308. In an embodiment, pads SDI 326 and SDO 325 represent the input pin and output pin respectively, to communicate with the serial input/output (I/O) interface 309.

In an embodiment, the various components of CMOS image sensor 300 require access to reference voltage supply and reference ground voltage levels. Pads IOVDD 316, DVDD 323 and V35 322 represent the reference voltage supplies and pads AGND 320 and IOGND 317 represent the reference ground levels that cater to various modules in the image sensor 300.

In an embodiment, the various modes in which the image sensor 300 can be operated can be set using the pads Mode1 313 and Mode2 314 shown in FIG. 3.

In an embodiment, the pad TOUT 315 is used to select the testing mode for the chip. In an embodiment, the pin TEST 312 is used to choose the test pattern from the built in pattern generator.

In the CMOS image sensor chip illustrated in FIG. 3, a pad VSINC 318 is shown as an optional pad. VSINC pad is usually required to synchronize an image sensor with other image sensors used in an application. However, in the embodiments described in the present specification, as a single image sensor is used having multiple image areas which are synchronized using a timing generator, the other image sensors may not be required and hence the pin VSINC may be redundant. In an embodiment, the pad VSINC is removed.

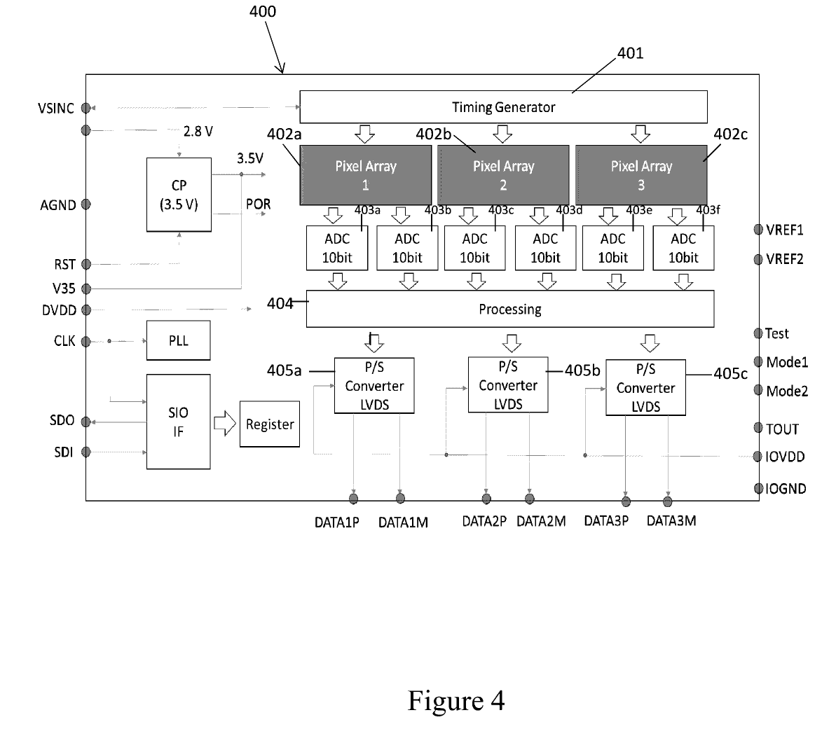

FIG. 4 illustrates the design layout of a CMOS image sensor 400 comprising multiple image areas 402a, 402b and 402c and a single processing unit 404 coupled to multiple P/S converter/LVDS modules 405a, 405b and 405c in accordance with an embodiment of the present specification. As shown in FIG. 4, the image sensor 400 comprises a timing generator 401 coupled to three pixel arrays or image areas 402a, 402b and 402c. In an embodiment, the timing generator 401 is controlled by the computer program/instructions stored in a memory register and provides the clock signals to synchronize all the image areas 402. Each of the image areas 402a, 402b and 402c is coupled to two 10 bit ADCs 403a to 403f which convert the analog pixel information into a digital format. As illustrated in FIG. 4, image area 402a is coupled to ADC 403a and ADC 403b. Similarly, image area 402b is coupled to ADC 403c and ADC 403d, and image area 402c is coupled to ADC 403e and ADC 403f. All the ADCs 403a to 403f are coupled to a single processing unit 404 such that the digitized pixel information generated by each of the ADCs 403a to 403f is received by the processing unit 404 which further processes the same. In an embodiment, the processing unit 404 converts the received imaging data into standard video formats such as MPEG 4 and HD Video. It may be appreciated that employing a single processing unit 404 instead of using separate processing units, such as in the embodiment illustrated in FIG. 3, leads to more efficient design layout and optimum utilization of chip space. However, as the processing unit 404 is required to process data received from multiple image areas, its processing capacity and speed will be reduced compared to the processing capacities and speeds of the processing units 304a, 304b and 304c in the above embodiment, each of which are dedicated to a single image area.

Though a single processing unit 404 is used to processes the imaging data received from multiple image areas 402a, 402b and 402c, after processing, the data corresponding to each image area 402a, 402b and 402c is transmitted using a separate parallel to serial interface 405a, 405b and 405c through a differential signaling mechanism. In an embodiment, the processing unit 404 is coupled to three P/S converter/LVDS modules 405a, 405b and 405c such that the data corresponding to image area 402a is transmitted using P/S converter/LVDS module 405a, data corresponding to image area 402b is transmitted using P/S converter/LVDS module 405b and the data corresponding to image area 402c is transmitted using P/S converter/LVDS module 405c.

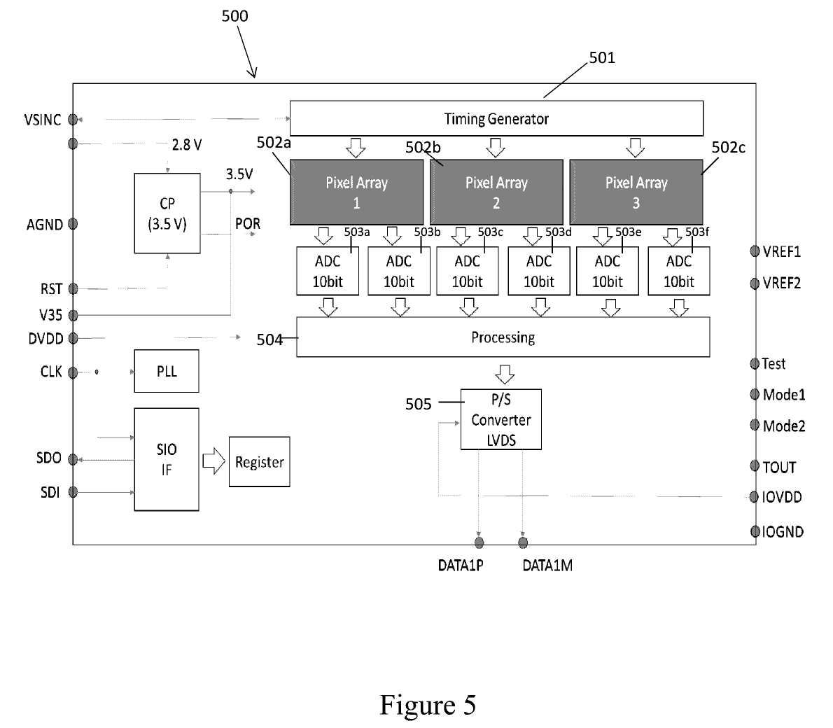

FIG. 5 illustrates the design layout of a CMOS image sensor 500 comprising multiple image areas 502a, 502b and 502c and a single processing unit 504 coupled to a single P/S converter/LVDS module 505 in accordance with an embodiment of the present specification. As shown in FIG. 5, the image sensor 500 comprises a timing generator 501 coupled to three pixel arrays or image areas 502a, 502b and 502c. In an embodiment, each of the image areas 502a, 502b and 502c is coupled to two 10 bit ADCs 503a to 503f which convert the analog pixel information into a digital format. As illustrated in FIG. 5, image area 502a is coupled to ADC 503a and ADC 503b. Similarly, image area 502b is coupled to ADC 503c and ADC 503d and image area 502c is coupled to ADC 503e and ADC 503f. All the ADCs 503a to 503f are coupled to a single processing unit 504 such that the digitized pixel information generated by each of the ADCs 503a to 503f is received by the processing unit 504 which further processes the same. It may be appreciated that employing a single processing unit 504 instead of separate processing unit for each image area makes the layout design more efficient but requires the processing unit 504 to have a higher processing capacity. The processing unit 504 further transmits the processed digital data using a single parallel to serial interface 505 through a differential signaling mechanism. For this purpose, the processing unit 504 is coupled to a single P/S converter/LVDS module 505 as illustrated in FIG. 5. In the above embodiment, the imaging data retrieved from each of the image areas 502a, 502b and 502c is processed and transmitted using a single processor 504 and a single parallel to serial converter/LVDS module 505. Employing a single P/S converter/LVDS module 505 again leads to design efficiency and optimal usage of the chip space, however, it requires a high speed P/S converter/LVDS module to provide a decent operational speed.

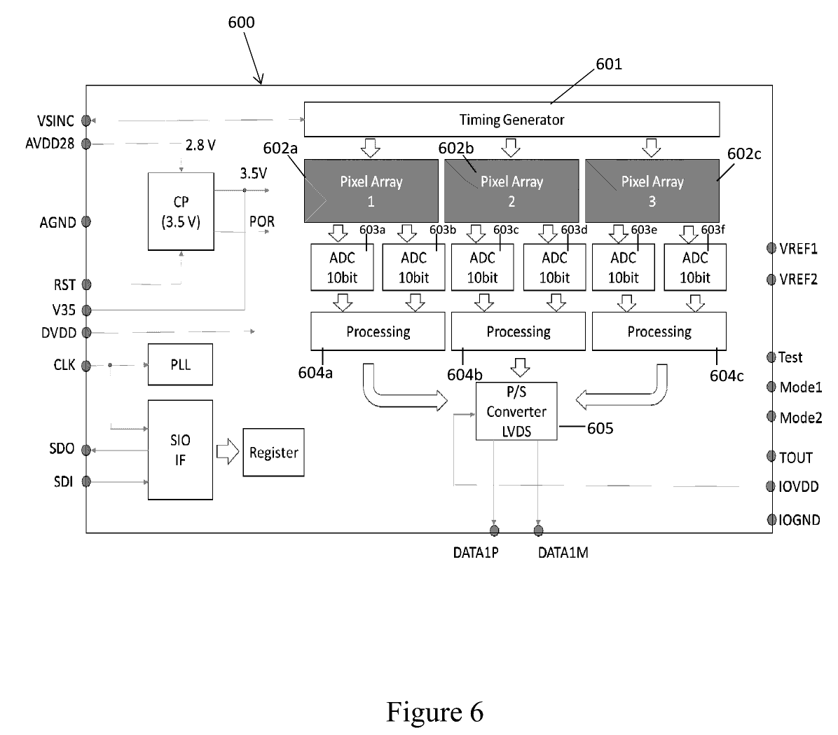

FIG. 6 illustrates the design layout of a CMOS image sensor 600 comprising multiple image areas 602a, 602b and 602c and multiple processing units 604a, 604b and 604c coupled to a single P/S converter/LVDS module 605, in accordance with an embodiment of the present specification. As shown in FIG. 6, the image sensor 600 comprises a timing generator 601 coupled to three pixel arrays or image areas 602a, 602b and 602c. In an embodiment, each of the image areas 602a, 602b and 602c, is coupled to two 10 bit ADCs 603a to 603f which convert the analog pixel information into a digital format. As illustrated in FIG. 6, image area 602a is coupled to ADC 603a and ADC 603b. Similarly, image area 602b is coupled to ADC 603c and ADC 603d and image area 602c is coupled to ADC 603e and ADC 603f. Each set of ADCs 603a to 603f corresponding to a specific image area are coupled to a dedicated processing unit. As shown in FIG. 6, ADC 603a and ADC 603b are coupled to a processing unit 604a. Similarly, ADC 603c and ADC 603d are coupled to a processing unit 604b and ADC 603e and ADC 603f are coupled to a processing unit 604c. It may be appreciated that using a dedicated processing unit to process the digitized pixel information retrieved from each image area makes the overall process of retrieving and processing the imaging data stored in CMOS image sensor fast. As the above embodiment employs parallel processing using multiple processors, the processing capacity of each single processor used in this embodiment can be lower than the processing capacity of a single processor described in the embodiment illustrated in FIG. 5.

In this embodiment, each of the processing units 604a, 604b and 604c further transmits the processed digital data through a single parallel to serial interface 605 through a differential signaling mechanism. Thus, all the processing units 604 are coupled to a single P/S converter/LVDS module 605 as illustrated in FIG. 6. In the above embodiment, the imaging data retrieved from each of the image areas is processed using a corresponding processor and subsequently transmitted using a single parallel to serial converter/LVDS module. Employing a single P/S converter/LVDS module again leads to design efficiency and optimal usage of the chip space, however it again requires a high speed P/S converter/LVDS module to provide a decent operational speed.

The image sensors of the present specification may be used in a tip section of an endoscope of a multiple camera endoscope system, wherein the endoscope system includes a main control unit coupled to a handle of an endoscope. The handle is used for controlling at least one functionality of the endoscope. An insertion tube is coupled to the control handle and includes a tip section at its distal end which is configured to house any of the image sensors disclosed in the present specification. The image sensor includes a plurality of pixel arrays wherein each pixel array is configured to store optical imaging data captured by a different camera positioned in said tip section.

FIG. 7A illustrates a system 700 comprising multiple cameras coupled with a single image sensor 707, in accordance with an embodiment of the present specification. As shown in FIG. 7, the system 700 comprises three imaging elements or lens assemblies 701, 702 and 703 corresponding to three different imaging devices or cameras and aligned in three different directions 711, 712 and 713. The image sensor chip 707, which in an embodiment is a CMOS image sensor, comprises three separate image areas, each area being adapted to receive data transmitted by the corresponding lens assembly 701, 702 and 703 in its direction. To ensure that the respective image areas located in the image sensor 707 receive the imaging data transmitted by the optical device corresponding to that specific image area, a prism 704, 705 and 706 is used with each optical device or the lens assembly 701, 702 and 703 to reflect the incoming light rays in the direction of corresponding image area. As shown in FIG. 7, a prism 704 is used to reflect the light rays transmitted by the lens assembly 701 in the direction of image area corresponding to lens 701. Similarly, a prism 705 is used to reflect the light rays transmitted by the lens assembly 702 in the direction of image area corresponding to lens 702 and a prism 706 is used to reflect the light rays transmitted by the lens assembly 703 in the direction of image areas correspond to lens 703. In an embodiment, each image area contained in the image sensor 707 comprises a two dimensional pixel array which stores the imaging data transmitted by the corresponding optical device.

In an embodiment, the architecture described in the above embodiment is used in a multiple viewing elements endoscope referred in the present specification. The lens assemblies 701, 702 and 703 correspond to the three camera units in the multiple viewing elements endoscope, such as one front camera unit and two side camera units.

FIGS. 7B and 7C illustrate the relative positions and orientations of multiple image areas 714, 724, 715, 725, 716, 726 on an image sensor 717, 727 in accordance with some embodiments of the present specification. FIG. 7B depicts rectangular shaped image areas 714, 715, 716 and FIG. 7C depicts isosceles triangle shaped image areas 724, 725, 726. In various embodiments, referring to FIGS. 7B and 7C simultaneously, a first image area 715, 725 is oriented with its long dimension parallel to a first direction x which corresponds to a pointing direction, or field of view, of a first viewing element, such as a front pointing camera, of an endoscope. A second image area 714, 724 is oriented with its long dimension parallel to a second direction y, and perpendicular to direction x, which corresponds to a point direction, or field of view, of a second viewing element, such as a first side pointing camera, of an endoscope. A third image area 716, 726 is oriented with its long dimension parallel to a third direction z, and perpendicular to direction x, which corresponds to a pointing directions, or field of view, of a third viewing element, such as a second side pointing camera, of an endoscope. In some embodiments, direction x points to a distal end of the endoscope such that image area 715, 725 is positioned on a distal end of the image sensor 717, 727 and image areas 714, 724 and 716, 726 are positioned proximal to image area 715, 725.

While rectangular and isosceles triangle shaped image areas are depicted in FIGS. 7B and 7C, any shaped image area may be used. In some embodiments, wherein the image areas have equal dimensions, such as squares and equilateral triangles, the image areas are oriented such that each image area is located on the image sensor in a position relative to its associated imaging element. For example, in an embodiment, for an endoscope having a front pointing camera, a first side pointing camera, and a second side pointing camera, a first square shaped image area associated with the front pointing camera is positioned on a distal end of the image sensor, a second square shaped image area associated with the first side pointing camera is positioned on a first side of the image sensor and proximal to the first image area, and a third square shaped image area associated with the second side camera is positioned on a second side of the image sensor, opposite said first side, proximal to the first image area and adjacent to the second image area.

FIG. 7D illustrates the relative positions and orientations of multiple image areas 734, 735, 736 on an image sensor 737 in accordance with another embodiment of the present specification. Referring to FIG. 7D, the image areas 734, 735, 736 are rectangular shaped and positioned adjacent one another along direction x. In an embodiment, image area 735 is associated with a front pointing camera of an endoscope, image area 734 is associated with a first side pointing camera, and image area 736 is associated with a second side pointing camera of the endoscope. In other embodiments, the image areas 734, 735, 736 are associated with any of the cameras of the endoscope and their relative positions on the image sensor 737 do not correspond to a particular pointing direction of the cameras.

FIG. 7E illustrates the relative positions and orientations of multiple image areas 744, 745, 746, 748 on an image sensor 747 in accordance with yet another embodiment of the present specification. Referring to FIG. 7E, the image areas 744, 745, 746, 748 are rectangular shaped and positioned adjacent one another along direction x. In an embodiment, image area 745 is associated with a front pointing camera of an endoscope, image area 744 is associated with a first side pointing camera, image area 746 is associated with a second side pointing camera, and image area 748 is associated with a third side pointing camera of the endoscope. In other embodiments, the image areas 744, 745, 746, 748 are associated with any of the cameras of the endoscope and their relative positions on the image sensor 747 do not correspond to a particular pointing direction of the cameras.

While rectangular shaped image areas are depicted in FIGS. 7D and 7E, any shaped image area may be used. In addition, in other embodiments, the image areas may be arranged in a direction along the y and z axis or, in an embodiment having four cameras and image areas, may be arranged in quadrants with two adjacent image areas at a distal end of an image sensor and the remaining two image areas at a proximal end of the image sensor.

The above examples are merely illustrative of the many applications of the system of present invention. Although only a few embodiments of the present invention have been described herein, it should be understood that the present invention might be embodied in many other specific forms without departing from the spirit or scope of the invention. Therefore, the present examples and embodiments are to be considered as illustrative and not restrictive, and the invention may be modified within the scope of the appended claims.

In the description and claims of the application, each of the words “comprise” “include” and “have”, and forms thereof, are not necessarily limited to members in a list with which the words may be associated.

We claim:

1. An image sensor comprising:
a plurality of pixel arrays, wherein each pixel array has a unique orientation and is configured to receive imaging data captured by a corresponding imaging device aligned in the direction of said pixel array; and
a plurality of analog to digital converters, each of the said converters being coupled to one of said plurality of pixel arrays to convert analog pixel information into a digital format.

2. The image sensor of claim 1, wherein said image sensor employs CMOS technology.

3. The image sensor of claim 1, further comprising a single processing unit coupled to the plurality of analog to digital converters.

4. The image sensor of claim 3, further comprising a differential signaling component adapted to transfer data processed by said processing unit.

5. The image sensor of claim 4, wherein said differential signaling component comprises a low-voltage differential signaling (LVDS) component.

6. The image sensor of claim 4, further comprising a data transfer module configured to transfer processed imaging data corresponding to each pixel array.

7. The image sensor of claim 1, further comprising a discrete processing unit coupled to each pixel array.

8. The image sensor of claim 7, further comprising a differential signaling component adapted to transfer data processed by said discrete processing unit.

9. The image sensor of claim 8, wherein said differential signaling component used for data transfer comprises low-voltage differential signaling (LVDS) component.

10. The image sensor of claim 8, further comprising a discrete data transfer module adapted to transfer imaging data processed by said discrete processing unit.

11. The image sensor of claim 1, wherein said image sensor is adapted to receive and store imaging data captured by a plurality of cameras or viewing elements positioned on the tip section of an endoscope.

12. An image sensor comprising:
a plurality of pixel arrays wherein each pixel array is configured to receive imaging data captured by a corresponding imaging device;
a plurality of analog to digital converters (ADCs), wherein each of said plurality of ADCs is coupled to at least one of said plurality of pixel arrays to convert analog pixel data into a digital format;
a plurality of discrete processing units, wherein each of said plurality of discrete processing units is coupled to at least one of said plurality of ADCs corresponding to each of said at least one of said plurality of pixel arrays for processing imaging data corresponding to said pixel array; and
a plurality of discrete data transfer modules, wherein each of said plurality of discrete data transfer modules is coupled to each of said plurality of discrete processing units for transmitting data processed by each of said plurality of discrete processing units using at least one differential signaling mechanism.

13. An image sensor comprising:
a plurality of pixel arrays wherein each pixel array is configured to receive imaging data captured by a corresponding imaging device;
a plurality of analog to digital converters (ADCs), wherein each of the plurality of ADCs is coupled to one of said plurality of pixel arrays to convert analog pixel data into a digital format;
a single parallel processing unit coupled to said plurality of ADCs to process imaging data corresponding to said plurality of pixel arrays; and
a data transfer module coupled to said parallel processing unit and adapted to transmit data processed by said single parallel processing unit using a differential signaling mechanism.

14. The image sensor of claim 13 further comprising a plurality of data transfer modules coupled to said parallel processing unit wherein each data transfer module is configured to transmit data corresponding to a specific one of said plurality of pixel arrays using a differential signaling mechanism.

15. An imaging system comprising:
a plurality of imaging elements aligned in three different directions and adapted to capture imaging data;
a prism associated with each of said imaging elements and configured to reflect light toward said plurality of imaging elements in each of the three different directions; and
an image sensor comprising:
a plurality of pixel arrays, wherein each of said plurality of pixel arrays has a unique orientation corresponding to each of said different directions and is configured to receive imaging data captured by a corresponding one of said plurality of imaging elements; and
a plurality of analog to digital converters, each of the plurality of analog to digital converters being coupled to one of said plurality of pixel arrays to convert analog pixel information into a digital format.

16. The imaging system of claim 15, wherein said image sensor employs CMOS technology.

17. The imaging system of claim 15, further comprising a single processing unit coupled to the plurality of analog to digital converters.

18. The imaging system of claim 15, further comprising a differential signaling component adapted to transfer data processed by said processing unit.
